(19) United States
(12) Patent Application Publication
(10) Pub. No.: US 2012/0061109 A1
(43) Pub. Date: Mar. 15, 2012

(54) SILENT RESPONDER FIRE FIGHTING SYSTEMS

(76) Inventor: Rudy Pavesi, Old Tappan, NJ (US)

(21) Appl. No.: 13/208,925

(22) Filed: Aug. 12, 2011

Related U.S. Application Data
(60) Provisional application No. 61/382,109, filed on Sep. 13, 2010.

(51) Int. Cl. A62C 35/02; A62C 2/00

(52) U.S. Cl. 169/46; 169/28

(57) ABSTRACT

Silent responder fire fighting systems comprises a method and apparatus for suppressing and combating a fire. In one embodiment, a silent responder projectile may be launched from either a short-range gun or a long-range rifle into a fire from a distance. In an alternative embodiment, silent responder fire fighting system may take the form of a hand grenade and may be activated and thrown strategically into a fire. The silent responder projectile of the present invention may comprise an exterior housing having a bullet-shape and comprising a heat-resistant, non-ferrous material such as aluminum. The inside of the silent responder projectile comprises a first ignition assembly, a second ignition assembly, and a potassium-based compound for suppressing a fire. In use, the first ignition assembly is activated upon firing the silent responder projectile from a projectile launcher. A time delay of about 5 seconds occurs before the first ignition assembly triggers the second ignition assembly. Thereupon, the fire suppressing agents are released through exhaust holes.

### CROSS-REFERENCE TO RELATED APPLICATION

The present application is related to and claims priority from prior provisional application Ser. No. 61/382,109, filed Sep. 13, 2010, and pending applications 2007/0068683, and 2007/0068687 which applications are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of fire fighting devices and more specifically relates to an ignitable fire fighting device that may be projected remotely into a fire (or manually and strategically positioned into a fire) and may serve to aid in combating the fire especially during the initial stages.

2. Description of the Related Art

Fires may occur at anytime and at any place. A fire often starts because of electrical failures, human error, or simply due to accidents or forces of nature. Regardless, a raging fire in a residential or commercial building is extremely dangerous and may result in severe damage up to and including complete destruction, loss of valuables, injury, and even death. The longer a fire burns, the bigger the fire grows and the more difficult it becomes to extinguish the inferno. Because it typically takes a fire department several minutes to respond to a fire call, the fire has a chance to grow exponentially until the fire fighters arrive to combat the flames.

Conventionally, fire fighters use fire hoses to battle a burning flame. If a fire is in a tall building, the fire fighters will resort to a lift or a crane to reach the higher floors. However, fire fighters are limited in their arsenal when attacking a fire during the fire's early stages. It is at this time when fighting a fire is most effective because the fire's growth may be restricted which may pay off tremendous dividends by preventing it from spreading undeterred. A more effective and dynamic tool is needed to combat fires at this critical point, and those fires in difficult to reach places.

Various attempts have been made to solve the above-mentioned problems such as those found in U.S. Pat. No. 7,478,680 to Sridharan; U.S. Pat. No. 7,341,113 to Fallis et al; U.S. Pat. No. 6,470,805 to Woodall et al; U.S. Pat. No. 7,896,092 to Reina; U.S. Pat. No. 7,836,965 to Korenkov et al; U.S. Pat. No. 6,732,725 to Doud; U.S. Pat. Nos. 7,832,493 and 7,461,701, both to Marc V Gross et al; and U.S. Pub. No. 2007/0007021 to Regan. This prior art is representative of projectile devices to combat fires. None of the above inventions and patents, taken either singly or in combination, is seen to describe the invention as claimed.

Ideally, a fire combating projectile device should enable a fire responder/fighter to effectively attack a fire from a distance to ensure the operator's safety, and yet, would operate reliably and be manufactured at a modest expense. Thus, a need exists for a reliable silent responder fire fighting system to battle a fire in its early stages and to access difficult-to-reach places and to avoid the above-mentioned problems.

### BRIEF SUMMARY OF THE INVENTION

In view of the foregoing disadvantages inherent in the known projectile fire fighting device art, the present invention provides a novel silent responder fire fighting system. The general purpose of the present invention, which will be described subsequently in greater detail, is to provide a fire combating projectile device comprising the shape of a shell having aluminum or other ferrous exterior composition and which may enable a fire responder (fighter) to attack a fire from a distance.

Silent responder fire fighting systems may provide fire fighters and fire responders with a fire suppressing arsenal to protect property and save lives by providing an effective method for extinguishing fires that may not be easily reached using conventional methods. The silent responder fire fighting systems may extinguish an indoor fire in seconds, thereby protecting occupants and assisting fire fighters. Furthermore, the present invention may permit fire fighters to respond and attack a fire before ladders, hoses, and other equipment is set up or available. The silent responder fire fighting systems may comprise a potassium-based compound and a colored dye which may be released upon explosion and may serve to assist fire fighters by locating the areas that have been treated. The present invention also serves to prevent emotional and financial losses as well as to minimize insurance claims.

A projectile embodiment of the present invention as disclosed herein may comprise a bullet-shaped projectile with an exterior made from aluminum or other suitable metal (or non-metal). It may have a base with a primer, which activates the contained accelerant. The projectile may comprise an igniter having approximately a five second delay (more or less in alternate embodiments). The igniter may activate an aerosol block, comprising a talc color mineral at the top. The solid aerosol block is preferably designed to dissolve into a gas and exit exhaust holes located at the base of the projectile. The colored talc may assist fire fighters in locating the area that has been treated. The aerosol block may further comprise an epoxy coating, which may enable a controlled burn of the aerosol. The aerosol may be comprised of potassium nitrate, DCDA, and resin, all which react with the flames to create an extinguishing effect. The device may be activated thermally, manually, or some combination thereof. A sensor may be located on the top of certain embodiments, which will activate the device when a preset temperature (thermal threshold) is reached.

In an alternative embodiment of the silent responder fire fighting systems, the projectile may take the form of a hand grenade. The hand grenade may comprise a multi-chamber enclosure and a grenade activator. The multi-chamber enclosure may comprise the aerosol block comprising a potassium-based compound for suppressing a fire. The hand grenade embodiment may be activated by removing a safety clip, holding the lever, and pulling a pull ring. The hand grenade may then be strategically thrown into a fire to combat the flames and spread of the fire. A kit and methods of use are also described herein for the present invention.

The present invention holds significant improvements and serves as a silent responder fire fighting system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, silent responder fire fighting systems, constructed and operative according to the teachings of the present invention.

FIG. 1 is a perspective view illustrating a silent responder fire fighting system in an in-use condition to help extinguish a fire in a burning house according to an embodiment of the present invention.

FIG. 2 is an exterior perspective view illustrating the silent responder projectile according to an embodiment of the present invention of FIG. 1.

FIG. 3 is an interior perspective view illustrating the silent responder projectile according to an embodiment of the present invention of FIG. 2.

FIG. 4A is a front perspective view illustrating a second ignition assembly of the silent responder fire fighting system according to an embodiment of the present invention of FIGS. 1-3.

FIG. 4B is a side perspective view illustrating the second ignition assembly of the silent responder fire fighting system according to an embodiment of the present invention of FIGS. 1-3.

FIG. 4C is an exploded view illustrating the second ignition assembly of the silent responder fire fighting system according to an embodiment of the present invention of FIGS. 1-3.

FIG. 5A is a perspective view illustrating a short-range gun in an armed-condition which may be used to launch the silent responder projectile into a fire from a short distance (range) according to an embodiment of the present invention of FIGS. 1-3.

FIG. 5B is a perspective view illustrating a long-range rifle in an armed-condition which may be used to launch the silent responder projectile into a fire from a longer distance according to an embodiment of the present invention of FIGS. 1-3.

FIG. 6 is an exterior perspective view illustrating a silent responder grenade according to an embodiment of the present invention of FIG. 1.

FIG. 7 is an perspective view illustrating an interior (cutaway) of the silent responder grenade according to an embodiment of the present invention of FIG. 6.

FIG. 8 is a perspective view illustrating the long-range rifle used to launch the silent responder projectile in an in-use condition according to an embodiment of the present invention of FIG. 1.

FIG. 9 is a flowchart illustrating a projectile method of use according to an embodiment of the present invention of FIGS. 1-5 and 8.

FIG. 10 is a flowchart illustrating a grenade method of use according to an embodiment of the present invention of FIGS. 6-7.

The various embodiments of the present invention will hereinafter be described in conjunction with the appended drawings, wherein like designations denote like elements.

### DETAILED DESCRIPTION

As discussed above, embodiments of the present invention relate to a silent responder fire fighting system and more particularly to a projectile and a grenade which may be launched into a fire to help suppress a fire in its early stage(s).

Silent responder fire fighting systems 100 may serve to protect property and save lives by providing an effective method for extinguishing fires 165 that may not be reached using conventional methods. This unique device is able to extinguish a small indoor fire 165 in seconds, thereby protecting occupants and assisting fire fighters 140 and fire responders 145. Further, silent responder fire fighting systems 100 allows fire fighters 140 and fire responders 145 to respond and attack fire 165 before ladders, hoses, and other equipment is set up or available.

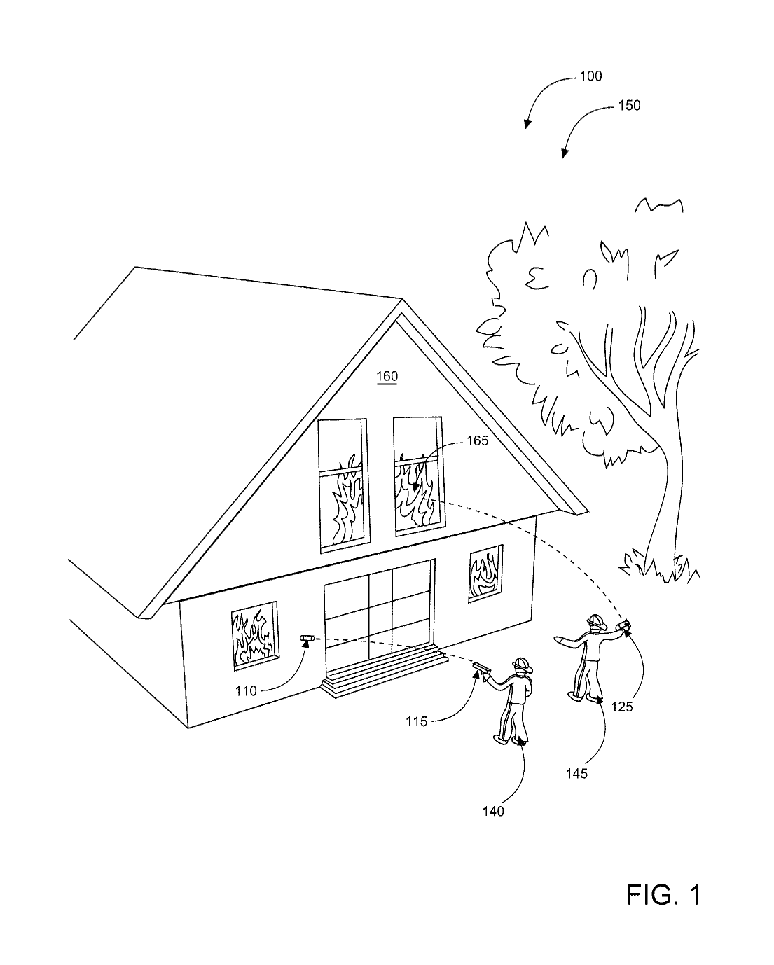

Referring to the drawings by numerals of reference there is shown in FIG. 1, silent responder fire fighting systems 100 in an in-use condition 150. Silent responder fire fighting system 100 may generally comprise two main embodiments, silent responder projectile 110 and silent responder grenade 125, both used for suppressing fire 165. As shown, fire fighter 140 and fire responder 145 are battling fire 165 that is burning within house 160. House 160 within this disclosure can be taken generally to refer to any dwelling, or non-dwelling including commercial buildings, out buildings, and various types of housing structures.

In one embodiment of the present invention shown in FIG. 1, fire fighter 140 is strategically firing silent responder projectile 110 into house 160 via projectile launcher 115. In another embodiment of the present invention also shown in FIG. 1, fire responder 145 is throwing silent responder grenade 125 into house 160 to stifle fire 165. In such a manner, fire fighter 140 and fire responder 145 may battle and suppress fire 165 from a safe distance while other fire fighting units set up their equipment. The present figure also illustrates how various forms of the invention may be used in conjunction with each other for a common purpose, albeit via different means and/or methods.

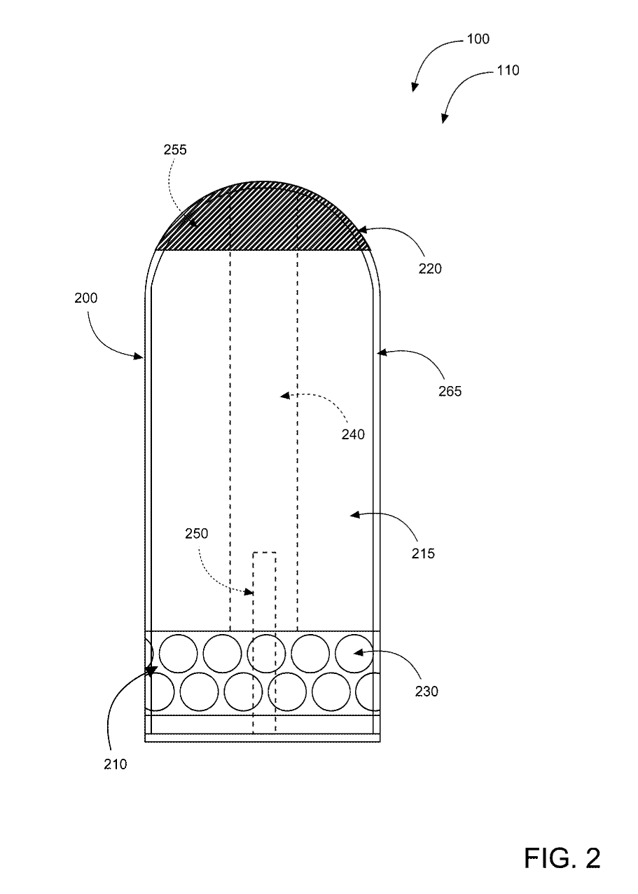

Referring now to FIG. 2, showing an exterior perspective of silent responder projectile 110 according to an embodiment of the present invention of FIG. 1. As shown, silent responder projectile 110 preferably comprises projectile housing 200 which may be substantially shaped like a bullet having an inner volume. The inner volume of projectile housing 200 may generally comprise base 210, body 215, and cap member 220. Ignition channel 240 may travel vertically throughout body 215 of projectile housing 200 and may provide a closed circuit from base 210 to cap member 220. Igniter 250 may be located at base 210 and may be positioned within ignition channel 240. Furthermore, the exterior of base 210 of projectile housing 200 may comprise a plurality of exhaust ports 230. Exhaust ports 230 may comprise circular-shaped apertures for releasing heat and exhaust from within base 210.

In continuing to refer to FIG. 2, the exterior of projectile housing 200 may comprise an aluminum, metal, alloy or other suitable material. In addition, the exterior surface of projectile housing 200 may comprise epoxy coating 265. Epoxy coating 265 may comprise a thermosetting polymer which possesses heat resistant and insulating properties thereby providing additional protection to projectile housing 200. Epoxy coating 265 may serve to enable a controlled burn of aerosol pellets 335. In alternative embodiments, projectile housing 200 may comprise non-ferrous material(s).

In FIG. 2, cap member 220 of projectile housing 200, as shown, may comprise an inner volume surrounding ignition channel 240. The inner volume of cap member 220 may be preferably filled with a potassium based compound and color marker 255 in preferred embodiments. In one embodiment of the present invention, the potassium based compound comprises potassium bicarbonate which may serve as a fire extinguishing agent. When silent responder projectile 110 ignites and is activated, the potassium based compound may serve to retard and extinguish fire 165. Alternatively, color marker 255 may comprise potassium nitrate, DCDA, and resin, which all react strategically with the flames to extinguish them. Further, upon explosion, color marker 255 may provide a visual marker to indicate to fire fighter(s) 140 and fire responder(s) 145 as to which section of fire 165 has been attacked by silent responder fire fighting systems 100.

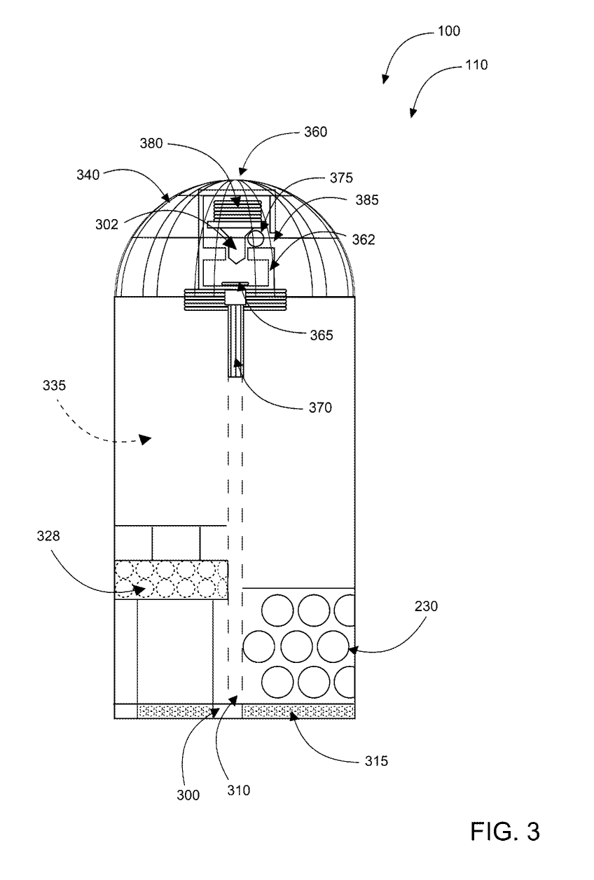

Referring now to FIG. 3 is a perspective view illustrating an interior of silent responder projectile 110 according to an embodiment of the present invention of FIGS. 1-2. As shown, base 210 of projectile housing 200 may comprise first ignition assembly 300. First ignition assembly 300 preferably comprises first primer 310 and accelerant 315. In one embodiment, accelerant 315 may comprise a hydrocarbon-based fuel which may serve as a catalyst for first ignition assembly 300 assisting by causing an increase in the speed of the ignition process. It should be noted that first primer 310 initiates the launching of accelerant 315 through ignition channel 240 which travels from first ignition assembly 300 to second ignition assembly 360. Consequently, there is approximately a 5 second delay between first ignition assembly 300 and second ignition assembly 360. It should be noted however that the time delay between first ignition assembly 300 and second ignition assembly 360 may be modified to permit more or less time by increasing the volume and strength of accelerant 315.

In still referring to FIG. 3, body 215 of projectile housing 200 comprises a compartment having an inner volume for storing alumina cooling 328. In one embodiment, alumina cooling 328 comprises an amphoteric oxide having a relatively high thermal conductivity of (30 Wm-1K-1[4]). This may serve to provide adequate cooling means for silent responder fire fighting systems 100. Further, body 215 may comprise aerosol pellets 335. Upon explosion, aerosol pellets 335 may scatter and serve to provide a visual marker as to which section of fire 165 has been attacked by silent responder fire fighting systems 100. In such a manner, fire fighter 140 may see which part of fire 165 has been struck by silent responder projectile 110 and may focus on other areas. In one embodiment of the present invention, aerosol pellets 335 may comprise the color talc. However, it should be appreciated that aerosol pellets 335 may comprise other colors and/or marking means as well.

In continuing to refer to FIG. 3, illustrating second ignition assembly 360 located within an inner volume of cap member 220 of projectile housing 200. As shown, second ignition assembly 360 may comprise second primer 365, striker 370, thermal ball 375, spring 380, and thermal ball exit hole 385. Second primer 365 may be substantially enclosed by second primer housing 362 thereby providing protection to second primer 365. In one embodiment of the present invention, second primer housing 362 may comprise brass. Second ignition assembly 360 may be enclosed by wire cage 340, wherein wire cage 340 preferably comprises a substantially dome-shaped wire member.

Spring 380 is in a coiled position and sandwiched between the top portion of second primer housing 362 and striker 370. Further, striker 370 is held in an upright position by thermal ball 375. Thermal ball 375 may generally comprise a small, round-shaped metal ball. Thermal ball exit hole 385 may comprise an aperture in second primer housing 362 that is slightly bigger in size than thermal ball 375. In such a manner, when thermal ball 375 is caused to exit through thermal ball exit hole 385, the tension in spring 380 is released causing striker 370 to contact second primer 365. Upon contact of second primer 365 by striker 370, the fire suppressing chemicals comprising aerosol pellets 335, color marker 255, and the potassium-based compound stored within body 215 and cap member 220 are released serving to stifle and extinguish fire 165. It should be noted that the aerosol pellets 335 dissolves into gas which exits through exhaust holes 230 located in base 210 of projectile housing 200. Further, epoxy coating 265 may assist in providing a controlled burn of aerosol pellets 335.

Activation of second ignition assembly 360 occurs subsequent to activation of first ignition assembly 300 which is caused by the firing of silent responder projectile 110 by projectile launcher 115. It should be appreciated that there is approximately a 5 second delay between activation of first ignition assembly 300 and second ignition assembly 360 which allows enough time for silent responder projectile 110 to be launched into a strategic position within fire 165 that is burning inside house 160 or other indoor structure. Further, as dependant on the application the present invention is used within delay times may be shorter or longer in duration.

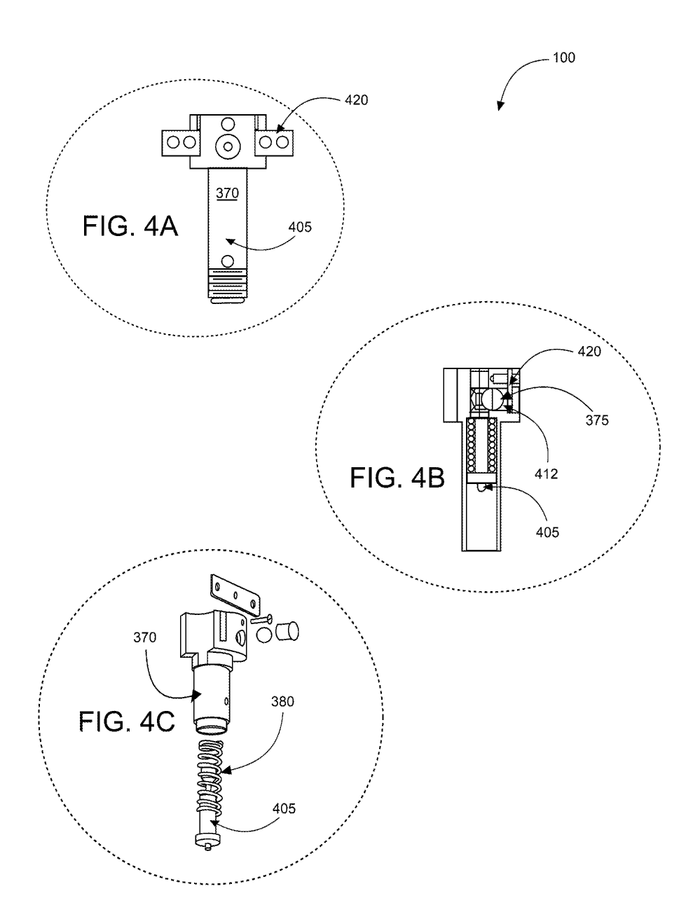

Referring now to FIGS. 4A, 4B, and 4C, illustrating a close-up view of striker 370 firing pin 405 of first ignition assembly 300. As shown in FIG. 4A, firing pin 405 may comprise retention tab 420. Retention tab 420 may comprise a releasable metallic strip that may serve as a temporary blocker in front of thermal ball exit hole 385. FIG. 4B is a side-perspective view of firing pin 405. As shown, an upper-portion of firing pin 405 may comprise fusible alloy 412. Fusible alloy 412 is a metal alloy comprising a fusible plug for retention tab 420.

In referring now to FIG. 4C specifically, FIG. 4C illustrating an exploded view of firing pin 405 of silent responder fire fighting systems 100 according to an embodiment of the present invention. When fusible alloy 412 is fused by first ignition assembly 300, retention tab 420 may be released, thereby causing thermal ball 375 to be pushed through thermal ball exit hole 385 by the pent up force within spring 380 that is held in a coiled state by striker 370. In such a manner, striker 370 is forcibly pushed down into contact with second primer 365 thereby triggering second ignition assembly 360.

It should be further noted that fusible alloy 412 may melt upon reaching a specific temperature thereby triggering the release of spring 380. Firing pin 405 is then retracted against the pressure of spring 380. Fusible alloy 412 may be assembled within thermal ball exit hole 385. Firing pin 405 may be deployed once thermal ball 375 exits through thermal ball exit hole 385 or when retention tab 420 is manually removed by a user. Retention tab 420 may serve to prevent the accidental deployment of firing pin 405.

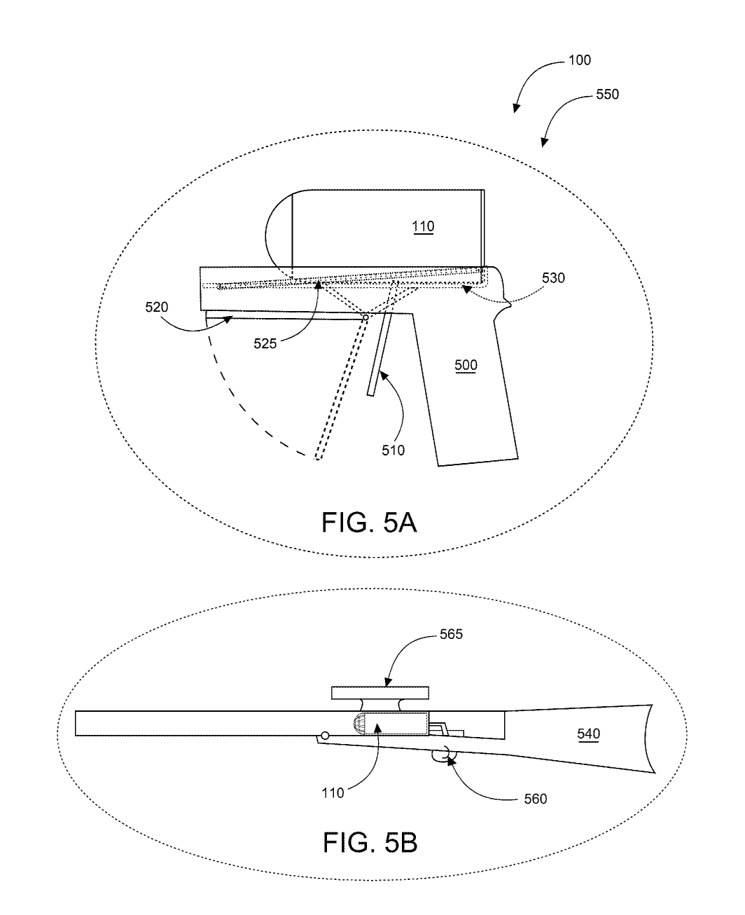

Referring now to FIG. 5A, illustrating short-range gun 500 in an armed-condition 550 which may be used to launch silent responder projectile 110 into fire 165 from a short distance (range) according to an embodiment of the present invention of FIGS. 1-3. As shown, short-range gun 500 may comprise load handle 520 for loading silent responder projectile 110 in rail 530. Further, short-range gun 500 may comprise spring 525 for retaining silent responder projectile 110 once loaded. In use, spring 525 may recoil upon activation of gun trigger 510 by fire fighter 140 thereby launching silent responder projectile 110 into the aimed direction. It should be noted that silent responder projectile 110 may comprise a low velocity of approximately 200 to 300 feet per second. This embodiment is useful for rough terrain, when shooting into multiple rooms, or when the fire has progressed to a point where the fire fighter 140 should stay at a safe distance.

Referring now to FIG. 5B, illustrating long-range rifle 540 in an armed-condition 550 which may be used to launch silent responder projectile 110 into fire 165 from an increased distance according to an embodiment of the present invention of FIGS. 1-3. Long-range rifle 540 may comprise an inner chamber for retaining silent responder projectile 110 in an armed condition 550 and may further comprise rifle trigger 560 for activating the firing of silent responder projectile 110. Long-range rifle 540 may further comprise sight 565 located on a top portion of long-range rifle 540 in order to approve accuracy and precision when aiming at a burning target. This may be especially useful when using silent responder fire fighting systems 100 to help stifle fire 165 located on a higher floor of a burning building or when the burning target is very small.

It should be noted that silent responder fire fighting systems 100 may be utilized with other similar projectile launchers including, but not limited to, rocket launchers, missile launchers, and grenade launchers.

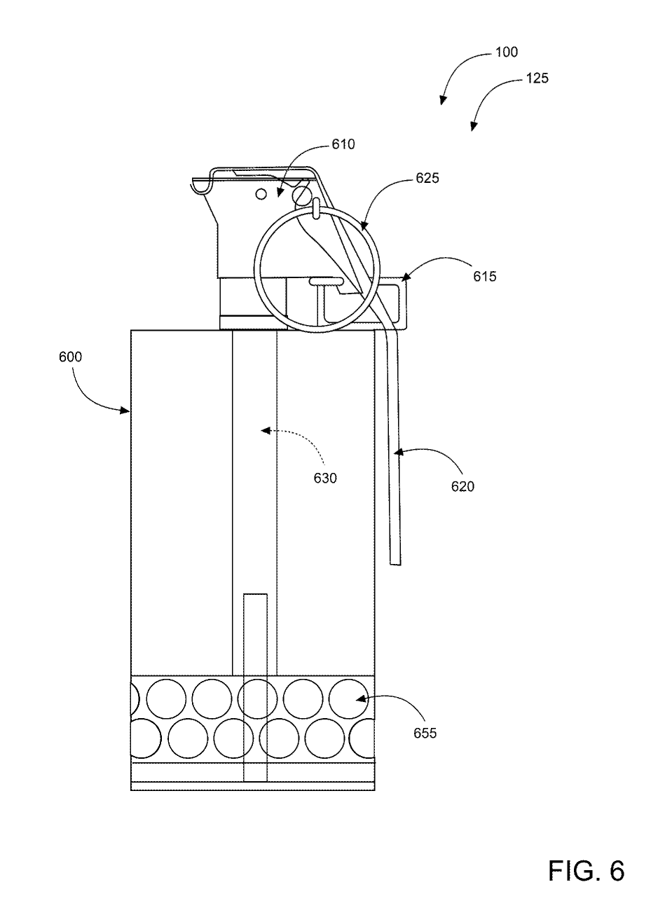

FIG. 6 is perspective view illustrating the exterior of silent responder grenade 125 according to an embodiment of silent responder fire fighting systems 100. Silent responder grenade 125 is designed to be hand-held (in this embodiment) and may enable fire fighter 145 to throw or manually place silent responder fire fighting system 100 into fire 165 without the assistance of projectile launcher 115. In such a manner, fire fighter 140 or fire responder 145 may quickly and immediately attack fire 165 without having to prepare projectile launcher 115.

As shown, silent responder grenade 125 may comprise multi-chamber grenade enclosure 600 which retains the fire suppressing compounds of silent responder grenade 125. Multi-chamber grenade enclosure 600 may comprise a non-ferrous material such as aluminum. Grenade activator 610 may be installed at the top of multi-chamber grenade enclosure 600 and may serve to activate silent responder grenade 125. As shown, grenade activator 610 may comprise safety clip 615, lever 620, and pull ring 625. Further, grenade ignition channel 630 may comprise a closed-circuit throughway that travels vertically throughout the center of multi-chamber grenade enclosure 600.

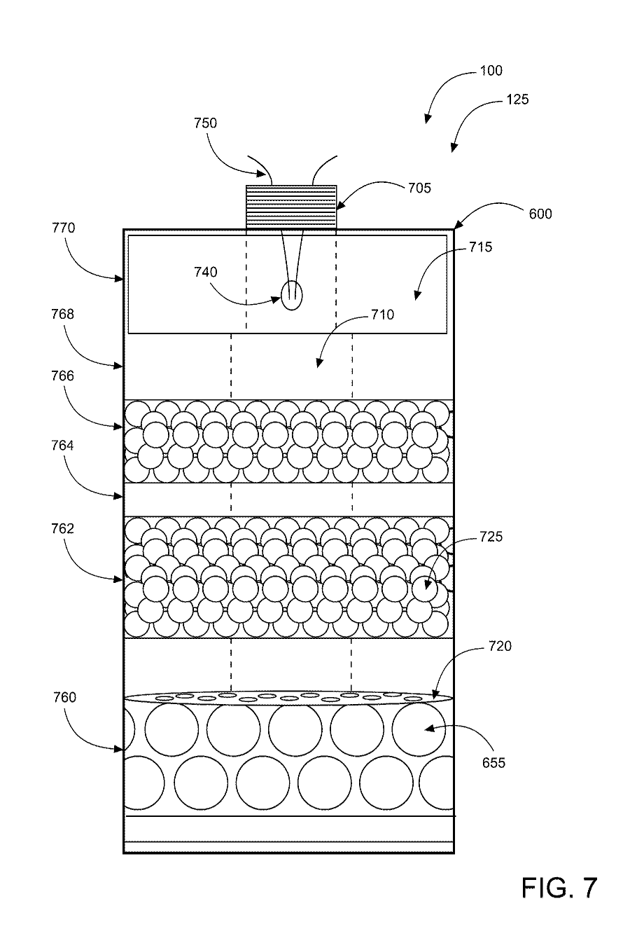

Referring now to FIG. 7, illustrating a perspective view of an interior of silent responder grenade 125 according to an embodiment of the present invention of FIG. 6. In order from bottom to top, multi-chamber grenade enclosure 600 generally comprises first chamber 760, second chamber 762, third chamber 764, fourth chamber 766, fifth chamber 768, and sixth chamber 770. Each chamber comprises a compartment having an inner-volume for storing fire suppressant compounds. Traveling vertically throughout the center of multi-chamber grenade enclosure 600 is grenade ignition channel 630.

In continuing to refer to FIG. 7, first chamber 760 may comprise spacer 710 and exit ports 655. Spacer 710 may comprise an empty compartment which may serve as a separator between chambers. As shown, second chamber 762 preferably comprises ceramic cooling beads 725. Ceramic cooling beads 725 may serve to provide a cooling and insulating means when silent responder grenade 125 is in an in-use condition 150. As further shown, third chamber 764 may comprise spacer 710, fourth chamber 766 may comprise ceramic cooling beads 725, fifth chamber 768 may comprise spacer 710, and sixth chamber 770 may comprise aerosol block 715. A detonation mechanism comprising electric match 740 may be positioned in the center of sixth chamber 770. In alternative embodiments, detonator mechanism may comprise an ignition assembly comprising fusible alloy. As shown in FIG. 7, threaded cap 705 may comprise a cap member which may threadably receive grenade activator 610. In such a manner, grenade activator 610 may screw onto threaded cap 705 and may secure to grenade activator connection 750. This enables grenade activator 610 to communicate with electric match 740 thereby igniting silent responder grenade 125 when pull ring 625 of silent responder grenade 125 is removed.

In still referring to FIG. 7, screen 720 may serve to separate first chamber 760 and second chamber 762. Screen 720 may comprise a divider comprising a plurality of apertures. Further, screen 720 may serve to separate second chamber 762 and third chamber 764, between third chamber 764 and fourth chamber 766, and between fourth chamber 766 and said chamber 768.

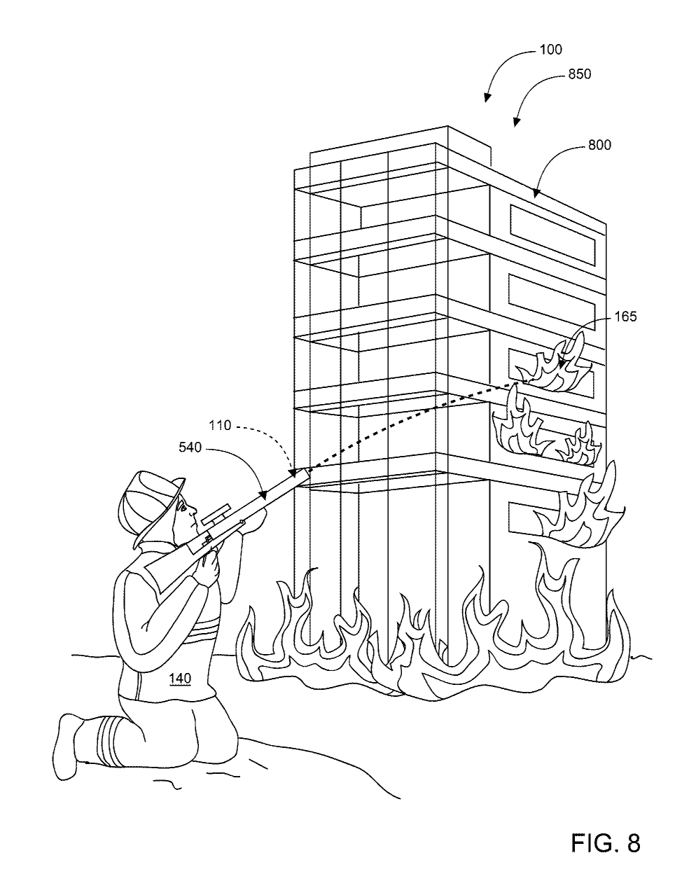

Referring now to FIG. 8, illustrating silent responder fire fighting systems 100 in an in-use condition 850 according to an alternative embodiment of the present invention. As shown, fire fighter 140 may launch silent responder projectile 110 into building 800 to combat fire 165 from a greater distance using long-range rifle 540. This may be especially useful when fire 165 is burning on a high floor of building 800. In such a manner, fire fighter 140 and fire responder 145 may suppress fire 165 until other fire combating units are able to set up hoses and ladders to assist. Every minute that fire 165 burns out of control without suppression may lead to further destruction of property, injury to others, and even death.

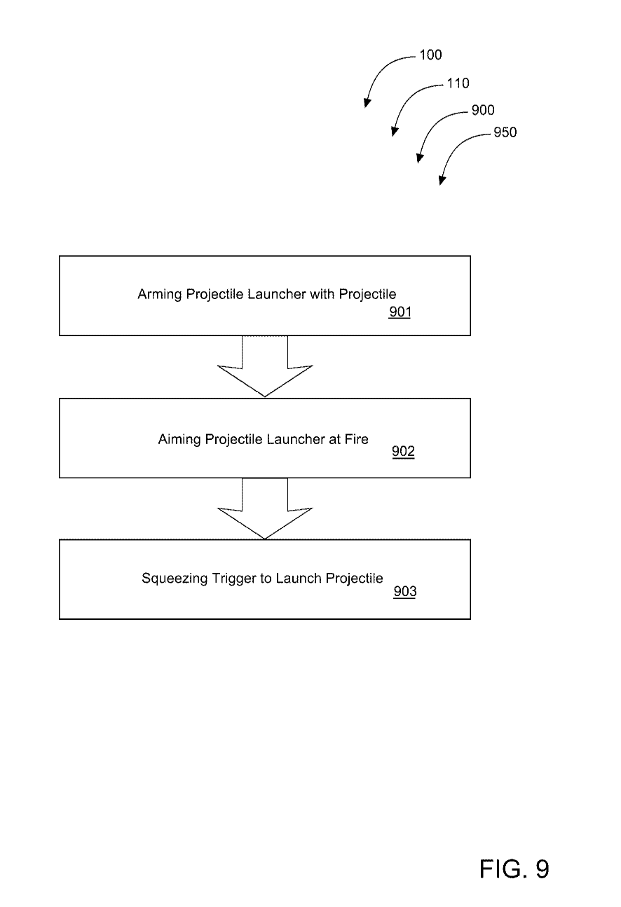

FIG. 9 shows projectile method flowchart 950 illustrating a projectile method of use 900 of silent responder fire fighting systems 100 according to an embodiment of the present invention of FIGS. 1-5 and 8. Projectile method of use 900 may comprise the steps of: step one 901 arming projectile launcher 115 with silent responder projectile 110, step two 902, aiming projectile launcher 115 at fire 165, and step three 903 squeezing gun trigger 510 to launch silent responder projectile 110. It should be noted that projectile launcher 115 may comprise short-range gun 500 or long-range rifle 540 according to a preferred embodiment of the present invention.

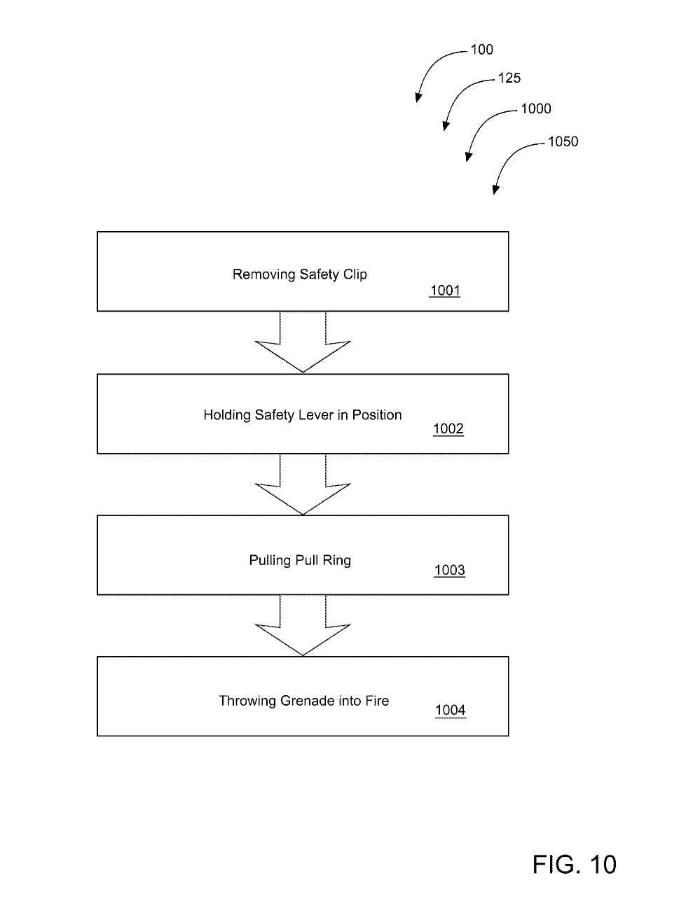

FIG. 10 is grenade method flowchart 1050 illustrating grenade method of use 1000 of silent responder fire fighting systems 100 according to an embodiment of the present invention of FIGS. 6-7. Grenade method of use 1000 may comprise the steps of: step one 1001 removing safety clip 615 from grenade activator 610, step two 1002 holding lever 620 of grenade activator 610 in position, step three 1002 pulling pull ring 625 of grenade activator 610, and step four 1003 strategically throwing silent responder grenade 125 into fire 165.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A projectile fire response system comprising:
at least one projectile housing including,
at least one base,
at least one body,
at least one cap member, and
an ignition channel having an igniter, said igniter comprising a first end and a second end; and
wherein said base comprises a base-inner-volume containing at least one first ignition assembly;
wherein said base comprises a plurality of exhaust ports;
wherein said body comprises a body-inner-volume for storing fire combating products;
wherein said cap member comprises a cap-inner-volume surrounded by a wire cage, said wire cage substantially enclosing at least one second ignition assembly;
wherein said igniter advances from said base through to said cap member within said ignition channel;
wherein said ignition channel defines an inner cylindrical volume that connects and directionally controls said first ignition assembly to said second ignition assembly such that said first ignition assembly can be activated preceding activation of said second ignition assembly; and
wherein said base, said body, and said cap member comprise a projectile fire response system for use in extinguishing a fire.

2. The projectile fire response system of claim 1 wherein said first ignition assembly comprises a first primer, and an accelerant, in communication with said first end of said igniter.

3. The projectile fire response system of claim 1 wherein said body comprises aerosol pellet(s).

4. The projectile fire response system of claim 1 wherein said body comprises non-ferrous material.

5. The projectile fire response system of claim 1 wherein said body comprises ferrous material.

6. The projectile fire response system of claim 1 wherein said body comprises epoxy coating.

7. The projectile fire response system of claim 1 wherein said cap member comprises a color marker.

8. The projectile fire response system of claim 7 wherein said color marker comprises potassium nitrate, DCDA, and resin.

9. The projectile fire response system of claim 1 wherein said second ignition assembly comprises a cover, a second primer, a striker, a thermal ball, and a spring, wherein said second ignition assembly is in communication with said second end of said igniter.

10. The projectile fire response system of claim 9, wherein said cover comprises an aperture providing an exit for said thermal ball.

11. The projectile fire response system of claim 1 wherein said body comprises a heat isolation layer comprising alumina.

12. The projectile fire response system of claim 1 wherein said igniter comprises a time delay fuse.

13. The projectile fire response system of claim 1 wherein said first ignition assembly is activatable via a projectile launcher.

14. The projectile fire response system of claim 1 wherein said projectile launcher comprises a short-range gun.

15. The projectile fire response system of claim 1 wherein said projectile launcher comprises a long-range rifle.

16. A grenade fire response system comprising:
at least one grenade housing including,
a multi-chamber grenade enclosure having a first chamber, a second chamber, a third chamber, a fourth chamber, a fifth chamber, and a sixth chamber,
at least one screwable cap, and
a grenade activator;
wherein said first chamber comprises a first spacer level and a plurality of exhaust exit holes;
wherein said second chamber comprises a first cooling layer comprising ceramic cooling beads;
wherein said third chamber comprises a second spacer level;
wherein said fourth chamber comprises second cooling layer comprising said ceramic cooling beads;
wherein said fifth chamber comprises a third spacer level;
wherein said sixth chamber comprises an aerosol block surrounding a detonation mechanism;
wherein screens are located between said first chamber and said second chamber, between said second chamber and said third chamber, between said third chamber and said fourth chamber, and between said fourth chamber and said fifth chamber;
wherein said screwable cap is threadably coupled to said grenade activator; and
wherein said grenade fire response system is manually activatable via said grenade activator and thrown into a fire as a fire response system for use in extinguishing said fire.

17. The grenade fire response system of claim 16, wherein said grenade activator comprises a safety clip, a lever, and at least one pull ring.

18. A method of use for an initial fire response system comprising the steps of;
activating a projectile; and
strategically placing said projectile from a remote location into a fire environment.

19. The method of use of claim 18, wherein the strategic placing of said projectile is accomplished via a projectile launcher.

20. The method of use of claim 18, wherein the strategic placing of said projectile is accomplished via manually throwing a grenade projectile.
